(19) United States
(12) Patent Application Publication
(10) Pub. No.: US 2008/0160633 A1
(43) Pub. Date: Jul. 3, 2008

(54) Catalyst treatment apparatus and process

(76) Inventors: Marcel J. G. Janssen, Kessel-Lo (BE); Cornelis W. M. Van Oorschot, Zemst (BE); Sabine Jurachno, Leuven (BE)

Correspondence Address: ExxonMobil Research and Engineering Company, P.O. Box 900, Annandale, NJ, 08801-0900, US

(21) Appl. No.: 11/998,774

(22) Filed: Nov. 30, 2007

Related U.S. Application Data
(60) Provisional application No. 60/877,271, filed on Dec. 27, 2006.

(51) Int. Cl. G01N 1/28; B01J 19/00

(52) U.S. Cl. 436/174; 422/198

(57) ABSTRACT

An apparatus for the sequential and/or parallel treatment of a plurality of molecular sieves samples is provided. The apparatus includes at least one support means having attached thereto a plurality of sample holders. The support means is in fluid communication with the interior of each sample holder. The apparatus also includes a tube furnace for receiving the support means, a means for supplying an inert gas, air, oxygen or a mixture thereof to each sample holder for a selected time period, a programmable device for sequentially directing the flow of inert gas, air, oxygen or a mixture thereof to each support means and each sample holder attached to the support means, and a means for varying temperature of the tube furnace. The apparatus also includes a means for supplying an ion exchange liquid or a source of a metal to each support means and each sample holder attached to the support means. Alternative apparatus for ion exchange or metal loading of molecular sieves is provided. Processes for the treatment of a plurality of molecular sieves samples are provided.

This application claims the benefit of U.S. Provisional application 60/877,271 filed Dec. 27, 2006.

### FIELD

This invention relates to apparatus and processes for the automatic and sequential or parallel treatment of a plurality of molecular sieves samples.

### BACKGROUND

Combinatorial Chemistry, also known as High Throughput Experimentation (HTE), is an emerging area of technology and science that has applicability in various technology fields. It is used in the pharmaceutical industry, as well as in the material science and chemical industries. It is widely recognized that the combinatorial synthesis methods can be a useful tool in increasing the rate of experimentation and improving and accelerating the possibility of making discoveries of new products or processes.

One potential area wherein HTE may be useful relates to the preparation and evaluation of molecular sieve materials which can serve as catalysts. Molecular sieve materials, both natural and synthetic, are known to have catalytic properties for various types of hydrocarbon conversion. Certain molecular sieve materials are ordered, porous crystalline aluminosilicates (zeolites), aluminophosphates (ALPOs) or silicoaluminophosphates (SAPOs) having a definite crystalline structure as determined by X-ray diffraction, within which there are a large number of smaller cavities which may be interconnected by a number of still smaller channels or pores. These cavities and pores are uniform in size within a specific molecular sieve material. Since the dimensions of these pores are such as to accept for adsorption molecules of certain dimensions while rejecting those of larger dimensions, these materials have come to be known as “molecular sieves” and are utilized in a variety of ways to take advantage of these properties.

Such molecular sieves, both natural and synthetic, include a wide variety of positive ion-containing crystalline aluminosilicates, aluminophosphates and silicoaluminophosphates. These materials can be described as having a rigid three-dimensional framework of SiO₄, and AlO₄, and in some cases PO₄, which form tetrahedra that are cross-linked by the sharing of oxygen atoms whereby the ratio of the total aluminum and silicon and possibly phosphorus atoms to oxygen atoms is 1:2. In crystalline aluminosilicates, the electrovalence of the tetrahedra containing aluminum is balanced by the inclusion in the crystal of a cation, e.g., an alkali metal or an alkaline earth metal cation. This can be expressed by the relationship of aluminum to the cations, wherein the ratio of aluminum to the number of various cations, such as Ca/2, Sr/2, Na, K, Cs or Li, is equal to unity. One type of cation may be exchanged either entirely or partially with another type of cation utilizing ion exchange techniques in a conventional manner. By means of such cation exchange, it has been possible to vary the properties of a given molecular sieve by suitable selection of the cation. The spaces between the tetrahedra are occupied by molecules of water prior to dehydration.

It is known that as-synthesized molecular sieves need to be modified to impart to them catalytic activity or improve such catalytic activity. For example, molecular sieves in the organic nitrogen-containing and alkali metal-containing form, the alkaline earth metal form and hydrogen form or another univalent or multivalent cationic form are catalytically-active. The as-synthesized molecular sieves may be conveniently converted into the hydrogen, the univalent or multivalent cationic forms by base exchanging the molecular sieves to remove the alkali metal, such as sodium cations, by such ions as hydrogen (from acids), ammonium, alkylammonium and arylammonium. The hydrogen form of the molecular sieves, useful in such hydrocarbon conversion processes as isomerization of poly-substituted alkyl aromatics and disproportionation of alkyl aromatics is prepared, for example, by base exchanging the sodium form with, e.g., ammonium chloride or hydroxide, whereby the ammonium ion is substituted for the sodium ion. The composition is then calcined, causing evolution of ammonia and retention of the hydrogen proton in the composition. Other replacing cations may be used, such as cations of metals other than sodium, e.g., metals of Group IIA, such as zinc, and Groups IIA, IVA, IB, IIB, IIIB, IVB, VIB and Group VIII of the Periodic Table, and rare earth metals and manganese.

Ion exchange of the molecular sieves can be accomplished in a conventional manner, such as by admixing the molecular sieves with a solution of a cation to be introduced into the molecular sieves. Ion exchange with various metallic and non-metallic cations can be carried out according to the procedures described in U.S. Pat. Nos. 3,140,251, 3,140,252 and 3,140,253, the entire contents of which are incorporated herein by reference.

Molecular sieves can also be used as catalysts in a combination with a hydrogenating component, such as tungsten, vanadium, molybdenum, rhenium, nickel, cobalt, chromium, manganese, or a noble metal such as platinum or palladium where a hydrogenation-dehydrogenation function is desired. Such component can be exchanged into the molecular sieve composition, impregnated therein or physically intimately admixed therewith. The exchange, impregnation or physical admixture can be referred to as “metal loading”. Such component can be impregnated in or onto the molecular sieve, for example, in the case of platinum, by treating the molecular sieve with a solution containing a platinum metal-containing ion. Thus, suitable platinum compounds include chloro-platinic acid, platinous chloride and various compounds containing the platinum tetramine-platinum complex. Combinations of the aforementioned metals and methods for their introduction can also be used.

Metal loading of molecular sieves can be carried out for a variety of reasons. For example, Wang et al., U.S. Pat. No. 7,119,242, discloses modifications of some molecular sieves with organometallic regents, such as dimethyl zinc. Liu et al., U.S. Pat. No. 6,448,197, discloses molecular sieve compositions having a surface heat impregnated with one or more metals of Groups IIA, IB, VIB, VB, VIIB or VIIIB. Toufor et al., U.S. Pat. No. 5,916,836 and Brandt, U.S. Pat. No. 6,407,025 disclose methods of manufacturing molecular sieves, such as zeolites, exchanged with lithium cations and, optionally, polyvalent cations. All of these patents are incorporated herein by reference.

It is also known that as-synthesized molecular sieves need to be treated to remove organic directing agents. The treatment usually includes calcination at temperatures ranging from about 200° to 600° C., such as about 450° to 550° C., or by chemically breaking up the organic obstruction, for example, by exposing the molecular sieves to ozone. E.g., see Degnan, Jr., U.S. Pat. No. 4,863,885.

Many synthetic molecular sieves, when employed either as an absorbent or as a catalyst in a hydrocarbon conversion process, should be at least partially dehydrated. This can be accomplished by heating the molecular sieves to a temperature in the range of about 200° C. to about 600° C. in an inert atmosphere, such as air or nitrogen for about 1 to about 48 hours. Simple dehydration of at least some molecular sieves can also be performed at lower temperatures, such as room temperature, merely by maintaining a molecular sieve in a vacuum, but a longer time is required to obtain a sufficient degree of dehydration.

When THE principles and techniques are used for synthesis of any given specific materials, such as molecular sieves, it may be necessary to provide specially designed apparatus and processes for high throughput modification and characterization of such specific materials. In so doing, one would look to the suitability of, and the potential need to modify, existing modification and characterization technology.

Several existing approaches have been proposed for HTE-type synthesis, screening and characterization of organic compounds and catalysts, such as homogeneous catalysts. For example, U.S. Pat. No. 6,419,881 proposes a method for the combinatorial syntheses, screening and characterization of libraries of supported and unsupported organometallic compounds and catalysts. U.S. Pat. No. 6,759,014 proposes an apparatus and methods for parallel processing of multiple reaction mixtures. U.S. Patent Application Publication 2003/0100119 proposes a combinatorial synthesis and screening of supported organometallic compounds and catalysts. U.S. Patent Application Publication 2004/0132209 suggests a multi-chamber treatment apparatus and method particularly for a simultaneous treatment of a plurality of materials, such as catalysts. Notwithstanding these existing approaches, a need nevertheless exists to develop new apparatus and processes for sequential and/or parallel treatment of a plurality of molecular sieve samples.

### SUMMARY

In one aspect, the invention is directed to an apparatus for treatment of a plurality of molecular sieves samples. The apparatus comprises a plurality of sample holders, at least one support means, including attached thereto a plurality of elongated, substantially vertically extending hollow tubes. Each hollow tube has attached thereto a plurality of sample holders. Each hollow tube is in fluid communication with the sample holders attached to the tube. The apparatus also includes a tube furnace (also referred to herein as a “tube oven”) for receiving the at least one support means; a means for supplying an inert gas, air, oxygen or a mixture thereof to each sample holder for a selected time period; a programmable device for sequentially directing the flow of inert gas, air, oxygen or a mixture thereof to each of the support means and each said sample holder; and a means for varying temperature of the tube furnace. The apparatus also includes a means for supplying an ion exchange liquid or a source of a metal to each support means and each sample holder.

Another embodiment of the invention is a process for the treatment of a plurality of molecular sieves samples. The process comprises providing a support means which includes a plurality of elongated, substantially vertically extending hollow tubes, each hollow tube including a plurality of sample holders attached thereto. The hollow tubes are in fluid communication with the sample holders on the respective hollow tubes. The molecular sieves samples are placed into the sample holders, and the support means is placed into the tube furnace. If the molecular sieves samples need to be initially calcined (e.g., to remove the organic structure directing agent), the samples are heated in the tube furnace, then a flow of a suitable gas, such as an inert gas (e.g., nitrogen, helium), air, oxygen or a mixture thereof is supplied into one or more of the hollow tubes, while substantially simultaneously a plurality of other hollow tubes is maintained under static gas atmosphere. Subsequently, the molecular sieves samples are cooled to a temperature suitable for ion exchange of the molecular sieves samples and an ion exchange liquid is supplied into one or more of the hollow tubes, while substantially simultaneously a plurality of other hollow tubes is maintained under static ion exchange liquid conditions, for a time necessary to effect a desired level of ion exchange in the molecular sieves samples. Thereafter the molecular sieves samples are washed and subsequently dried in a suitable gas, such as an inert gas (e.g., nitrogen, helium), air, oxygen or a mixture thereof. In some cases, washing may not be necessary.

An alternative embodiment of a process comprises providing a support means which includes a plurality of elongated, substantially vertically extending hollow tubes, each hollow tube including a plurality of sample holders attached to the tube. The hollow tubes are in fluid communication with the sample holders. Molecular sieves samples are placed into the sample holders, and then the support means is placed in a tube furnace. Subsequently the molecular sieves samples are heated in the tube furnace to a temperature suitable for ion exchange and an ion exchange liquid is supplied into one or more of the hollow tubes, while substantially simultaneously maintaining a plurality of other hollow tubes under static ion exchange liquid conditions. The ion exchange liquid is supplied into one or more of the hollow tubes, while the plurality of other hollow tubes is maintained under static ion exchange liquid conditions for a time necessary to effect a desired level of ion exchange. The ion-exchanged molecular sieves samples are then washed and subsequently dried in a suitable gas, such as an inert gas (e.g., nitrogen, helium), air, oxygen or a mixture thereof. In some cases, washing may not be necessary.

Yet another embodiment is directed to an apparatus for the treatment of a plurality of molecular sieves samples, comprising a plurality of modified Soxhlet extractors, with each modified Soxhlet extractor comprising an enclosure which includes a container for a molecular sieves sample, an inlet conduit connected to an inlet of the enclosure and an outlet conduit connected to an exit of the enclosure. The apparatus also includes a vessel for a treatment solution connected through the outlet conduits to the enclosures; conducting means for conducting the treatment solution from the vessel to the enclosures; and a means to regulate temperature of the treatment solution in the vessel. The conducting means may include a pump, an intake conduit (also referred to herein as “intake pipe”) from the vessel to the pump, or a transfer conduit connected to the inlet conduit.

There is also provided a process for treating a plurality of molecular sieves samples in the apparatus of this embodiment. The process comprises placing the molecular sieves samples into the containers of the modified Soxhlet extractors, directing the treatment solution (such as an ion exchange or a metals-loading solution) to each container in the enclosures through the inlet conduit, allowing the treatment solution to reach a pre-determined level in the enclosures and causing the treatment solution to exit the enclosures through the outlet conduits into the vessel. The process is conducted for a sufficient time to obtain a necessary level of ion exchange or metal loading of the molecular sieves samples. The molecular sieves samples may then be washed and dried in a suitable gas, such as an inert gas (e.g., nitrogen, helium), air, oxygen or a mixture thereof. Again, in some cases, washing may not be necessary.

A yet another embodiment of the apparatus for treating a plurality of molecular sieves samples comprises a vessel containing an ion exchange solution, the vessel also including a means to circulate (or stir) the solution, and a means to adjust temperature of the solution. The vessel also includes a means to maintain a plurality of molecular sieves samples in the vessel. The molecular sieves samples may be included in dialysis membrane tubes, portions of dialysis membrane tubes and/or in dialysis membrane portions, each of the dialysis membrane tubes, portions thereof and/or dialysis membrane portions including at least one molecular sieve sample.

A process for the treatment of a plurality of molecular sieve samples with the apparatus of the embodiment of the preceding paragraph includes incorporation of at least one molecular sieve sample into each of a dialysis membrane tube, a portion thereof and/or a dialysis membrane portion, placing each dialysis membrane tube, a portion thereof and/or dialysis membrane portion into the vessel which has the ion exchange solution and a circulation means, maintaining the vessel at a temperature needed to effect ion exchange of the molecular sieves samples, circulating (or stirring) the ion exchange solution, and maintaining the dialysis membranes tubes, portions thereof and/or the dialysis membrane portions in the vessel for a sufficient time to effect a desired degree of ion exchange. The molecular sieves samples may then be washed and dried in a suitable gas, such as an inert gas (e.g., nitrogen, helium) air, oxygen or a mixture thereof. In some cases, washing may not be necessary.

All embodiments directed to ion exchange may be used to conduct metal loading with suitable metal solutions.

### BRIEF DESCRIPTION OF THE DRAWINGS

FIG. 1 is a schematic depiction of one embodiment of our invention.

FIG. 1A is an illustration of an embodiment of a sample holder

FIG. 2 is a schematic depiction of an alternative embodiment of the invention.

FIG. 2A is an illustration of one embodiment of a Soxhlet thimble.

FIG. 2B is a schematic depiction of yet another alternative embodiment of the invention.

FIG. 3 is a schematic depiction of yet another embodiment of the invention.

### DETAILED DESCRIPTION

Our invention is directed to apparatuses and processes for efficiently and automatically carrying out sequential and/or parallel treatment of a plurality of molecular sieves.

The apparatuses and processes are directed to high throughput modification of materials, particularly molecular sieves. Preferably, the molecular sieves modified in the apparatuses and processes have been synthesized according to HTE principles. The molecular sieves which can be modified include as synthesized molecular sieves materials, and molecular sieves formulated for industrial applications. In industrial applications, the molecular sieves are combined with a suitable binder (e.g., alumina) then extruded into a cylindrical or other suitable shape, or in the case of catalytic cracking, the molecular sieve/alumina mixture may be spray dried to produce a 100-250 micron spherical particles.

In one embodiment, the apparatus includes at least one support means which supports a plurality of sample holders. The support means is in fluid communication with the sample holders it supports. Each support means comprises a plurality of substantially vertically extending elongated, hollow tubes. Each support means may include four to twelve, four to eight, four to six or four hollow tubes. Each tube may support (or has attached to it) a plurality of sample holders, such as four to twelve, four to eight, four to six or four sample holders. Each tube is in fluid communication with the sample holders it supports, such as with the interior of each sample holder attached to the tube. “Fluid communication” means that a fluid, such as a gas, or liquid, may be directed to flow from the tube to each sample holder and then from the sample holder to the tube upon a signal from a suitable control device, such as a conventional programmable device or a computer-controlled valve or switch, which are known in the industry. In operation, one or a plurality of sample holders contain a sample of a molecular sieve.

The apparatus also includes a tube furnace which can receive the support means, and a means for varying temperature of the tube furnace. The means for varying the tube furnace temperature may include a thermostatic device coupled to an appropriate heater.

The apparatus further includes a means for supplying a suitable gas, such as an inert gas (e.g., nitrogen, helium), air, oxygen or a mixture thereof to each tube and thus to each sample holder. Such means may include a conventional source of the aforementioned suitable gas or gases, a suitable pump, a suitable network of pipes and the control device. The control device can direct the flow of the gas or gases to one or more hollow tubes, while substantially simultaneously maintaining other hollow tubes under gas atmosphere. “Static gas atmosphere” means that a hollow tube (and the sample holders supported by it) is (are) substantially maintained under an atmosphere of a particular, suitable gas, such as the inert gas (e.g., nitrogen or helium), air, oxygen or a mixture thereof, which is not moving.

The apparatus comprises a means for supplying an ion exchange liquid (or a source of a metal for metal loading) to the support means and thus to each sample holder. The means for supplying the ion exchange liquid may comprise a vessel which includes a solution (such as an aqueous or essentially non-aqueous solution) of a soluble salt of a cation to be introduced into the molecular sieve. The vessel is connected to the hollow tubes via suitable piping, and the control device can direct the ion exchange liquid to the selected hollow tubes (and thus the sample holders of the selected tubes) as needed, while substantially simultaneously maintaining other hollow tubes under static liquid conditions, “Static liquid conditions” means that a hollow tube (and the sample holders supported by it) contains a particular liquid, such as an ion exchange solution, which is not moving.

If it is desired to introduce a metal functionality (instead of conducting ion exchange) into the molecular sieves samples, the same vessel as is used for ion exchange (or a different vessel) may be utilized, which contains a suitable solution of the metal. The vessel is connected to the hollow tubes and the flow of the metal solution is controlled by the control device. The connections of the vessel and the hollow tubes, and control of the metal solution is substantially the same as for the ion exchange embodiment.

In one embodiment, each sample holder is closed to an outside environment, other than being in fluid communication with the hollow tube that supports it. A suitable sample holder may be, e.g., an “8VCR” coupling containing two metal filters, one each at the entrance and exit of the coupling. The 8VCR coupling comprises (i) a gland (SS-8-VCR-3-8TA) (ii) a tube fitting connector (SS-8-VCR-6-810 and (iii) a nut (SS-8-VCR-1). The 8VCR coupling is available from Swagelok.

Sample holders may also be constructed using Swagelok fittings and SS frits, e.g. Swagelok SS-890-6. Generally, the sample holders may have dimensions of about 2 to about 10 cm in length, and construction such that they are able to retain a solid, and yet enable a fluid, such as an ion exchange liquid or a suitable gas (discussed herein), to enter the sample holders, contact the molecular sieve samples and exit the sample holders. Thus, the sample holders should have a solid retention or device at the entrance and exit, which is permeable to fluids. The sample holders may be made from any suitable material, such as stainless steel, hastelloy, titanium, aluminum, glass, quartz or a suitable rigid type polymer. If the sample holder is an 8VCR coupling, the molecular sieve sample to be ion exchanged is placed between the two filters. The filters' dimensions are such that the molecular sieve particles or the molecular sieve containing particles to be ion exchanged are contained within the sample holder.

The sample holders have an entrance opening and an exit opening. The entrance opening is connected to the tube supporting the sample holder, and the exit opening is connected to the tube downstream from the point of connection of the entrance opening to the tube. The entrance opening receives a fluid from the tube; the fluid contacts the molecular sieve sample in the sample holder, and exits the sample holder downstream into the tube. The sample holders may contain powdered molecular sieves, or pelletized and crushed or formulated molecular sieves with a particle size of 25 to 150 μm. If need be, the as-synthesized molecular sieves samples can be initially calcined in the apparatus of this embodiment, prior to ion exchange (or metal loading), to remove the organic structure directing agent used in the synthesis of the molecular sieve. The calcination proceeds by loading the molecular sieves into the sample holders of all the hollow tubes of the support means and introducing the support means into the tube furnace (which also may be referred to herein as a “tube oven”). The tube furnace is usually preheated to a desired calcination temperature before the support means is introduced. Alternatively, the support means may be introduced into the tube furnace which is below the desired calcination temperature and subsequently the tube furnace is heated to the required calcination temperature. The heat-up rate which is used varies from 1° C./min to about 25° C./min.

The control device directs the flow of the suitable gas or gases (discussed above) for a selected time period sequentially to a fraction of the hollow tubes, such as 25-40%, 25-35% or 25% of the hollow tubes, on the support means, while substantially simultaneously maintaining the remaining hollow tubes under static conditions. After the selected time period, the control device switches the flow of inert gas, air, oxygen or a mixture thereof to the next hollow tube(s) and substantially simultaneously maintains the remaining hollow tubes under static gas conditions. In one embodiment, one hollow tube has the flow of suitable gas or gases directed to it, while 3 to 10 hollow tubes are maintained under a static gas atmosphere. The selected time periods may range from about 0.5 to about 10 minutes, about 1 to about 10 minutes, about 0.5 to about 5 minutes, about 1 to about 4 minutes, about 1 to about 3 minutes, about 1 minute to about 2 minutes, about 1 minute or 1 minute. This procedure continues until each of the hollow tubes has been under the calcination gas flow for the time period needed for the calcination. The length of time for the tubes maintained under static gas conditions is dictated by the length of time that other tubes are maintained under the calcination gas flow conditions. The rate of the inert gas, air, oxygen or a mixture thereof flow is such as is needed (in combination with the length of exposure of the molecular sieves samples to the calcination gas) to accomplish a sufficient degree of calcination.

After the calcination is completed, the tube oven is cooled to the temperature desired for ion exchange (or introduction of a metal functionality) and a flow of the ion exchange solution (or a solution of a suitable metal for metal loading) begins. This embodiment will be described as it is used for ion exchange. This embodiment is used for the introduction of a metal functionality in substantially the same manner as for ion exchange (except a suitable metal solution is used instead of an ion exchange solution). The control device directs the flow of the ion exchange solution (or metal solution) for a selected time period sequentially to each hollow tube. The control device directs the flow of the ion exchange solution sequentially to each hollow tube in substantially the same manner as the suitable gas or gases (was) were directed during the calcination cycle described above. Thus, the control device directs the ion exchange solution flow to a fraction of the hollow tubes, e.g., 25-40%, 25-35% or 25%, of the hollow tubes on the support means, while substantially simultaneously maintaining the remaining hollow tubes under static liquid conditions. In one embodiment, the control device directs the ion exchange solution to one hollow tube, while 3 to 10 hollow tubes are maintained under a static gas atmosphere.

After the selected time period, the control device switches the flow of the ion exchange solution to the next fraction of the hollow tube(s). The selected time periods may range from about 0.5 to about 10 minutes, about 1 to about 10 minutes, about 0.5 to about 5 minutes, about 1 to about 4 minutes, about 1 to about 3 minutes, about 1 minute to about 2 minutes, about 1 minute or 1 minute. This procedure continues until each of the hollow tubes has been under the ion exchange liquid flow conditions for the time period needed to achieve a desired level of ion exchange. The rate of the ion exchange solution flow is such as is needed (in combination with the length of the sequential exposure of the molecular sieves samples on each hollow tube to the ion exchange liquid) to accomplish a sufficient level of ion exchange.

Subsequently, the flow of the ion exchange solution (which may also be referred to herein as “ion exchange liquid”) is terminated and the samples are dried using suitable gas or gases, as discussed above, (i.e., an inert gas, e.g., nitrogen or helium, air, oxygen or a mixture thereof) at the desired temperature. Alternatively the samples can be washed with water or any other suitable washing liquid (e.g., an alcohol) prior to drying by replacing the ion exchange solution with water or the suitable washing liquid (e.g., an alcohol). If needed, the samples can be calcined again after the drying step and the second ion exchange and washing, if necessary, can be conducted. The cycle can be repeated as often as desired.

If calcination is not required, the ion exchange or metal loading is conducted as described above, without the calcination step.

Conventional devices, such as suitable pumps and piping are used to direct suitable gases (such as an inert gas, e.g., nitrogen, or helium, air, oxygen or a mixture thereof), ion exchange and metal solutions into hollow tubes of the support means. The hollow tubes may be made from a material suitable for the apparatus and process described herein, e.g., from metal, such as (silica-coated) stainless steel, copper, hastelloy, quartz, or glass. The hollow tubes may have any suitable cross-section, such as circular, rectangular, square, or triangular cross-section. The hollow tubes may have length dimensions of about 2 cm to about 25 cm, and a diameter of about 0.5 cm to about 10 cm. The hollow tubes are rigidly attached to each other to form a rigid, unified support means.

The sample holders are attached to the tubes in any suitable manner. For example, the sample holders may be attached by conventional means such as Swagelok, or Gyrolok connectors.

In an alternative embodiment, an apparatus for treating a plurality of molecular sieves samples comprises a plurality of modified Soxhlet extractors.

As is known to those skilled in the art, a Soxhlet extractor is a device originally designed for extraction of lipids from a solid test material.

Typically, a dry test material is placed inside a “thimble” made from a porous cellulose material, e.g., a filter paper, which is loaded in the Soxhlet extractor. The extractor is attached to a flask placed under the extractor. The flask contains a solvent (commonly diethyl ether or petroleum ether). A condenser is placed above the flask and is connected to the flask. The solvent is heated, causing it to evaporate. The hot solvent vapor travels up to the condenser, where it cools, and is converted into liquid, which drips down onto the test material. The chamber containing the test material slowly fills with warm solvent until, when it is almost full; it is emptied by siphon action, back down to the flask. This cycle may be repeated many times. During each cycle, a portion of the lipid dissolves in the solvent. However, once the lipid reaches the solvent heating flask, it stays in the flask. It does not participate in the extraction cycle any further. The solvent may be evaporated and the mass of the lipid remaining in the flask is measured.

The Soxhlet extractors are modified for use in this embodiment. The condenser is eliminated. Also, the flask is eliminated and, instead, a separate vessel for the treatment solution is used.

Each of the modified Soxhlet extractors comprises an enclosure which includes a thimble container for a molecular sieve sample, an inlet conduit connected to the entrance of the modified extractor and an outlet conduit connected to the exit of the modified extractor. The inlet conduit is connected to a conducting means which includes a pump, connected via a suitable pipe or conduit to the vessel, and a transfer conduit which connects the pump to the inlet conduit. A treatment solution, such as an ion exchange solution, is introduced through the inlet conduit into the top of each Soxhlet extractor, and is directed to the thimble containing the molecular sieve sample. When the level of the ion exchange solution reaches a certain height in the Soxhlet extractor, the liquid is drained through siphon action from the enclosure, through the outlet conduit into the vessel which contains the ion exchange solution. The ion exchange solution can be recirculated back into the modified Soxhlet extractors. The vessel containing the ion exchange solution may include a means to regulate temperature of the solution, e.g., thermostatic water or oil or bath. This process is continued until the desired level of ion exchange has been reached. Subsequently, the molecular sieves samples are dried with the suitable gas or gases, discussed above i.e., inert gas, e.g., nitrogen or helium, air, oxygen or a mixture thereof. Alternatively, the samples can be washed with water or any other suitable washing liquid (e.g., an alcohol) prior to drying by replacing the ion exchange solution with water or the suitable washing liquid (e.g., an alcohol). The same procedure can be used for metal loading of molecular sieves with an appropriate solution of the desired metal. The modified Soxhlet extractors are arranged in parallel to each other, and their number may vary based on a number of factors, such as the volume of molecular sieves to be treated and the desired timing for completion of the treatment. The temperature of the vessel which contains the ion exchange solution may be controlled by any conventional means to maintain the treatment solution at a desired temperature. For example, the vessel can be controlled by a suitable heater and a thermostatic apparatus arrangement, e.g. a thermostatic water or oil bath.

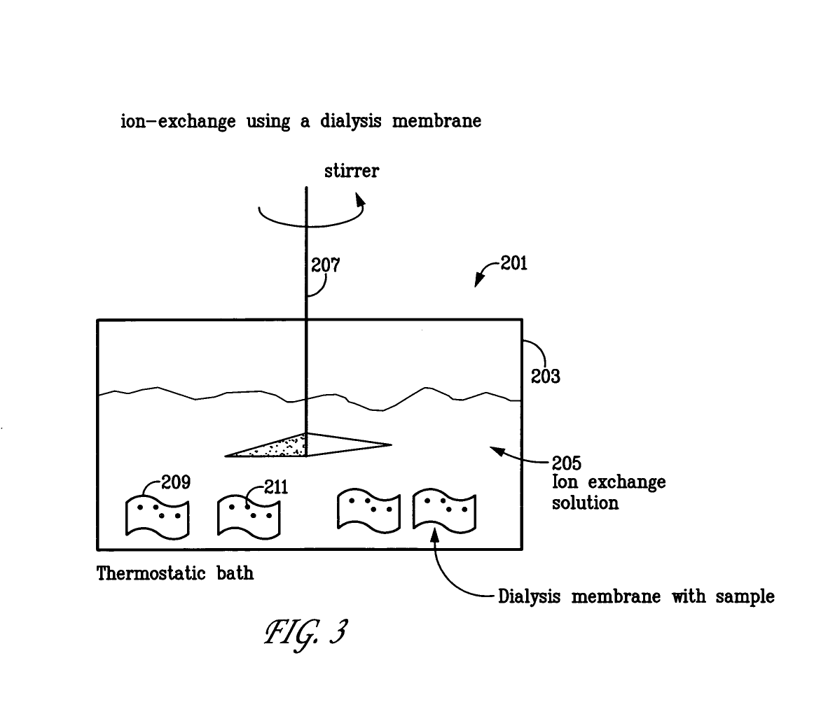

A schematic representation of an embodiment utilizing the modified Soxhlet extractors is illustrated in FIG. 3 (discussed in detail below), which is a non-limiting depiction of one example of such embodiment. The enclosure, which may include a thimble container, may have any suitable shape, such as a cylindrical, rectangular or square cross-section and volume of about 50 to about 5,000 ml. The enclosure may be made of any suitable material, such as stainless steel, glass or quartz. The thimble may be permeable to liquids, e.g., it may be made of a metal mesh material or porous cellulose material, with such dimensions of openings that would keep the molecular sieve sample inside the thimble. Alternatively, the thimble may be made of porous glass, porous silicates, porous borsilicates, porous metal or porous ceramics. The thimbles may have dimensions of about 20 to about 230 mm in length and diameter of about 20 to about 50 mm (if the thimbles are circular in cross-section). Thimbles may also have different cross-sections, e.g., elliptical, rectangular or square. Instead of thimbles, dialysis membrane tubes may be used, which are known in the art. Briefly, a dialysis membrane tube comprises a dialysis membrane material, rolled into a tube, fastened (e.g., tied) at the top and bottom. In this embodiment, the dialysis membrane tubes contain molecular sieve samples inside the tubes.

A suitable pump may be used to circulate the ion exchange solution from the vessel to the modified Soxhlet extractors. The pump may be connected to the vessel through an intake pipe. The outlet of the pump may be connected directly to the inlet conduit or to a transfer conduit, which is connected to the inlet conduit. Each inlet conduit includes a valve which controls the rate of flow of the ion exchange solution to each enclosure. The valves may also be used to stop the flow of the ion exchange solution into individual modified Soxhlet extractors (if less than all the extractors are needed). At least one of the inlet conduit, the transfer conduit, or the outlet conduit may have a means to vary their temperature, such as heat tracing. This embodiment may also be used for metal loading of molecular sieves by substituting a suitable metal solution for an ion exchange solution.

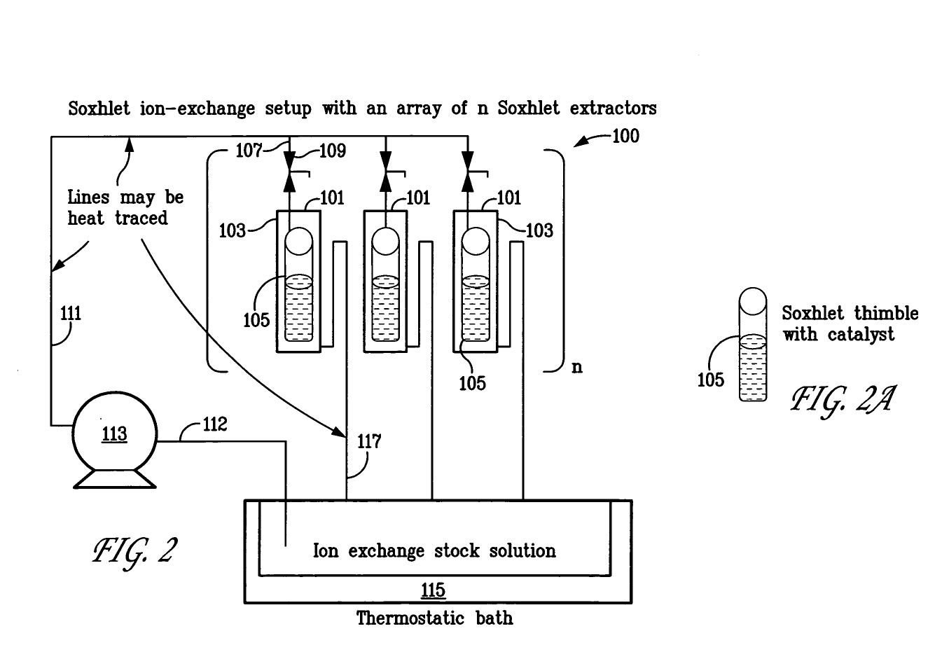

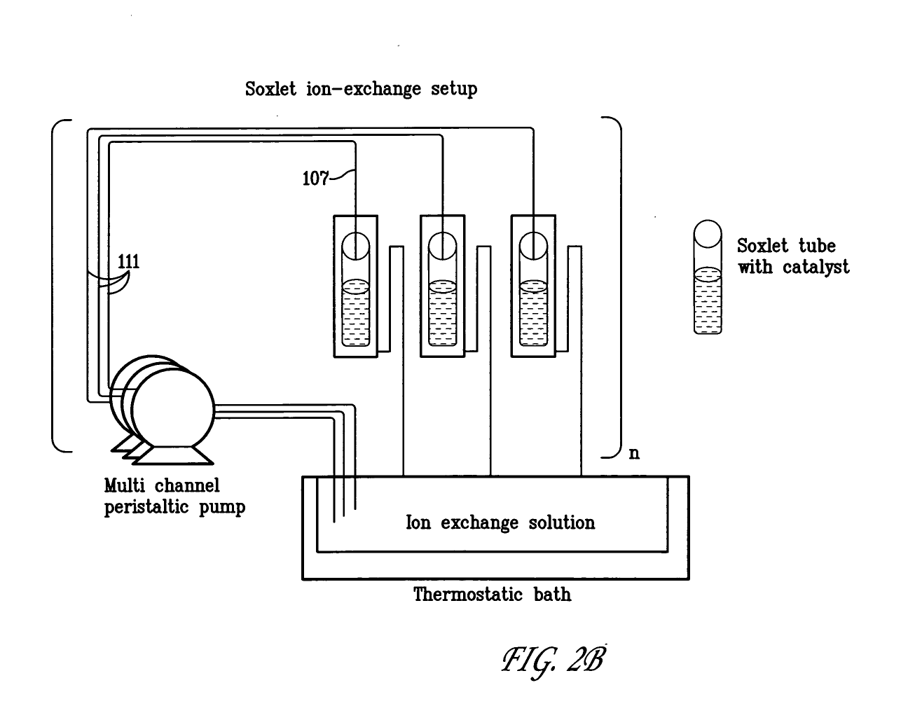

Alternatively a multi channel peristaltic pump maybe used to circulate the ion exchange solution from the vessel to the modified Soxhlet extractors as illustrated in FIG. 2B. The apparatus of FIG. 2B operates in substantially the same manner as that of FIG. 2, except that the multi-channel peristaltic pump supplies the ion exchange solution to each of the Soxhlet extractors through individual transfer conduits 111 and inlet conduits 107. No valves on the inlet conduits are necessary, because the flow of the solution is controlled by each channel of the peristaltic pump.

In yet another embodiment, multiple dialysis membrane tubes (or portions of dialysis membrane tubes) or a plurality of dialysis membrane portions are used to effect ion exchange (or metal loading) of molecular sieves. In this embodiment, each dialysis membrane tube (or a portion of the dialysis membrane tube or a dialysis membrane portion) includes a sample of the molecular sieve to be ion exchanged. The multiple dialysis membrane tubes (or portions thereof) or dialysis membrane portions are immersed in an ion exchange solution. The solution may be circulated around the dialysis membrane tubes (or their portions) or the dialysis membrane portions with a suitable apparatus, such as a stirrer. The dialysis membrane tubes are usually available in standard length of about 10 meters. The term “a portion of a dialysis membrane tube” means a section of the dialysis membrane tube which is shorter than the standard length thereof, e.g., about 5 to about 10 cm length. The term “a dialysis membrane portion” means a section of a dialysis membrane suitable for supporting a sample of a molecular sieve for ion exchange in this embodiment.

The molecular sieve samples are incorporated into each dialysis membrane tube (or a portion thereof) or a dialysis membrane portion and the tubes, their portions or dialysis membrane portions are maintained in the ion exchange solution for a sufficient time to effect the desired level of ion exchange. The vessel containing the ion exchange solution and the dialysis membrane tubes (or their portions) or dialysis membrane portions includes a means for regulating temperature of its contents. Such means may be a conventional thermostatic apparatus in conjunction with a conventional heater. The composition and structure of the dialysis membrane tubes (portions thereof) or dialysis membrane portions is not critical, so long as they have such properties which will enable the ion exchange solution to provide a sufficient level of ion exchange into the samples of molecular sieves. Suitable dialysis membranes are those available from Spectra/Por Biotech, located at Rancho Dominguez, Calif. One type of dialysis membrane available from Spectra/Por Biotech that can be used is a polyvinylidene difluoride (PVDF) dialysis membrane tube, with MWCO 500,000 (i.e., it allows migration through the membrane of peptides having molecular weight of 500,0000), see, for example, www.spectrumlabs.com, article number 131 908. Additionally, membranes can be used which are described in Thomas, U.S. Patent Application Publication No. 2003/0102262 A1, and Marze, U.S. Pat. No. Re 34,239, the contents of both which are incorporated herein by reference.

The dialysis membrane tubes (or their portions) have the dimensions of about 5 mm to about 25 mm in diameter. The dialysis membrane portions may have any suitable dimensions, such as about 2 cm to about 20 cm, or about 2 to about 10 cm in length. The dialysis membrane tubes (portions thereof) or dialysis membrane portions are free floating in the vessel or can be secured by any conventional means. The vessel may include a means to circulate the ion exchange solution around the dialysis membranes, such as a suitable stirrer. The samples of molecular sieves may be incorporated into the dialysis membrane tube (the portion thereof) or the dialysis membrane portions in any suitable manner e.g. as crystals; as crushed powder; as formulated catalyst; as spray dried particles. This embodiment may also be conducted in the same manner as the ion exchange process, discussed above, with a suitable metal solution.

In all embodiments, after the ion exchange is completed, the molecular sieves samples are dried using suitable gas or gases, as discussed above, (i.e., an inert gas, e.g., nitrogen or helium), air, oxygen or a mixture thereof at the desired temperature. Alternatively the samples can be washed with water or any other suitable washing liquid, (e.g., an alcohol) prior to drying by replacing the ion exchange solution with water or the suitable washing liquid (e.g., an alcohol).

The embodiments described herein provide relatively simple and inexpensive processes and apparatus for sequential and/or parallel treatment of a plurality of molecular sieves samples.

The processes and apparatus are particularly suitable for treating relatively small quantities of molecular sieves, typically between 5 mg and 50 g of molecular sieves.

The described embodiments also provide relatively simple, convenient, inexpensive and speedy processes for treating a plurality of molecular sieves samples, thereby increasing throughput, relative to some prior art techniques.

In all embodiments computers or similar devices may be utilized to control certain components and process operations, e.g., to control valves. A dedicated, single computer (or similar device) may be used to control each component or process operation or one computer (or similar device) may be used to control a plurality of components or process operations.

Some features of the embodiments are discussed in the following examples. These examples are presented for illustrative purposes only, and they do not limit the scope of the invention, which is defined by the entire specification and claims.

### EXAMPLE 1

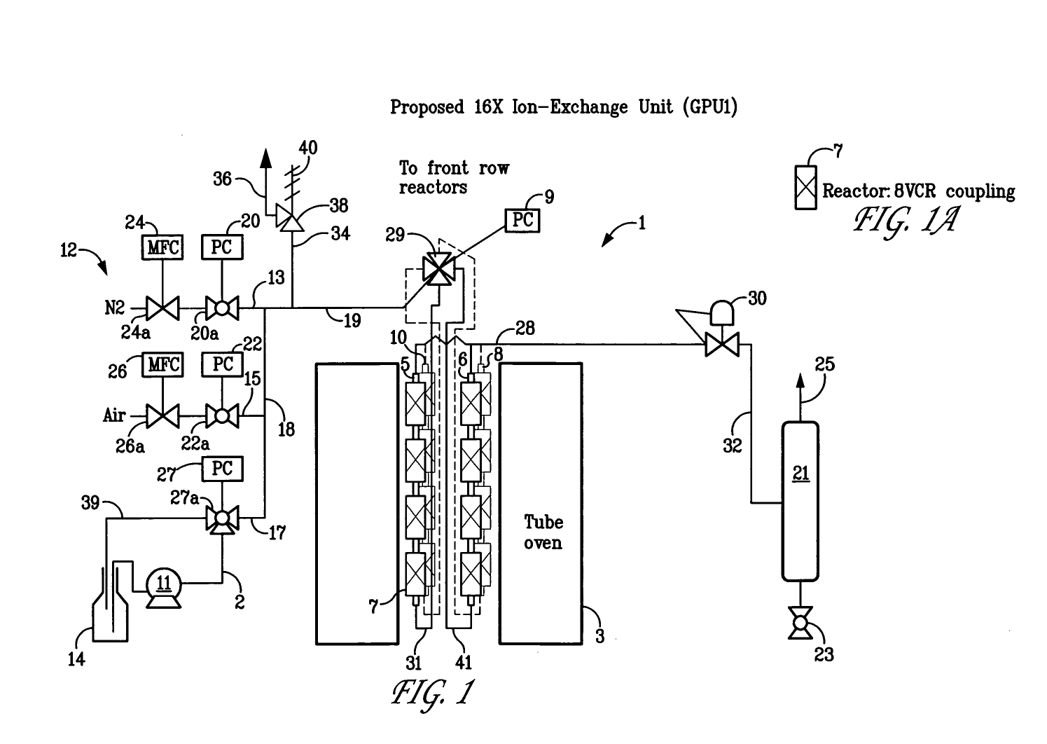

FIG. 1 is a schematic representation of the embodiment of the invention utilizing a tube furnace, discussed above. The apparatus 1 comprises a tube furnace 3 (shown in cross-section), and a support means formed by substantially parallel to each other hollow tubes 5, 6, 8 and 10. Each of the hollow tubes is connected to a conduit linking the hollow tubes with a computer 9-controlled valve 29. For example, the hollow tube 5 is connected to a conduit 31 and hollow tube 6 to a conduit 41 (the remaining two conduits are illustrated by dotted lines in FIG. 1). Each of the hollow tubes has four sample holders 7 attached to it. The sample holders are spaced from each other along the length of each tube, by a suitable distance, such as about 1 cm to about 5 cm. A pump 11 is used to deliver an ion exchange solution or metal solution from a vessel 14 into a conduit 17, a manifold 18 and a conduit 19. A computer 27-controlled valve 27a can be used to control flow of the solution. A conduit 39 may be used to redirect the solution to the vessel 14, to stabilize the liquid flow. Each sample holder 7 consists of an “8VCR” coupling containing one metal filter at the entrance and one metal filter at the exit of the coupling. The molecular sieve sample to be ion exchanged is placed between the two filters. The support means, including the four hollow tubes, each containing four sample holders, is placed inside the tube furnace, which is maintained at a temperature suitable for calcination. If the molecular sieves samples contain organic structure directing agents, they first may need to be calcined to remove such agents.

The samples are calcined for a time sufficient and at a sufficient temperature under a suitable gas, such as an inert gas (e.g., nitrogen, helium), air, oxygen or a mixture thereof atmosphere to remove the directing agents. The gas or gases is (are) directed to the hollow tubes by a network of conduits, generally designated as 12, including conduits 13, and 15, computer operated valves 20, 20a, 22, 22a and MFC controllers 24, 24a, 26, 26a [“MF”=“MASS FLOW”]. Suitable sources of nitrogen and air are connected to the conduits 13 and 15. A computer-controlled switch 9 directs the gas flow sequentially through the valve 29 to each of the four hollow tubes. For example, if a hollow tube 5 is under a flow of nitrogen or air atmosphere for one minute, the other three tubes, 6, 8 and 10 are under a static gas atmosphere. After the one minute cycle, the computer controlled switch directs nitrogen or air to the tube 6, and hollow tubes 5, 8 and 10 are under a static gas atmosphere. This rotation may continue for as long as necessary. In one embodiment, after four minutes, each of the tubes will be under the nitrogen or air flow for one minute and under static gas atmosphere for three minutes. The nitrogen or air is conducted through a conduit 31 into the hollow tube 5, which conducts the gas into the sample holders. The gas or gases enter the bottom-most sample holder, through its entrance opening at the bottom of the sample holder, contact the molecular sieve sample and egress through an exit opening of the sample holder at the top thereof, which is connected to the tube 5. The gases (e.g., nitrogen and/or air) enter the hollow tube 5 and proceed upwardly, to treat each consecutive molecular sieve sample in each of the remaining three sample holders on the hollow tube 5. The gases exit the hollow tube 5 at the top and are directed via a conduit 28 and a back pressure controller (BPC) 30 and conduit 32 to a collection vessel 21. The collection vessel has a valve 23 for discharge (if necessary) of liquid solution, and a vent conduit 25 to discharge gases or direct them to a suitable gas collection device. The nitrogen or air is conducted similarly through the remaining hollow tubes.

When the calcination is completed, the tube furnace is cooled to the temperature suitable for ion exchange, and the flow of the ion exchange liquid is commenced. Computer controlled switch 9 directs the flow of the ion exchange liquid sequentially from a vessel 14 to each of the four hollow tubes, in the same manner as the computer controlled switch 9 directed the gases (such as inert gases, oxygen and/or air) flow during the calcination cycle. The ion exchange liquid is directed by a pump 11 into the conduit 2, then computer 27-controlled valve 27a, conduit 17, and then into conduits 18 and 19. A computer-controlled switch 9 directs the ion exchange solution flow sequentially through the computer controlled valve 29, to each of the four hollow tubes. For example, if a hollow tube 5 is under a flow of the ion exchange solution for one minute, the other three tubes, 6, 8 and 10 are under static ion exchange solution conditions. After the one minute cycle, the computer-controlled valve 29 directs the ion exchange solution to the tube 6, and hollow tubes 5, 8 and 10 are under a static ion exchange conditions. This rotation may continue for as long as necessary. In one embodiment, after four minutes, each of the tubes will be under the ion exchange flow for one minute and under static ion exchange conditions for three minutes. The ion exchange solution is conducted through a conduit 31 into the hollow tube 5, which conducts the ion exchange solution into the sample holders 7 on the hollow tube 5. The ion exchange solution enters the bottom-most sample holder, through its entrance opening at the bottom of the sample holder, contacts the molecular sieve sample and egresses through an exit opening of the sample holder at the top thereof. The ion exchange solution then enters the hollow tube 5 and proceeds upwardly, where the solution contacts molecular sieves samples in each of the remaining three sample holders on the hollow tube 5. The ion exchange solution exits the hollow tube 5 at the top and is directed via the conduit 28 and BPC 30 and conduit 32 to the collection vessel 21. The collection vessel has a valve 23 for discharge (if necessary) of ion exchange solution, and a vent conduit 25 to discharge any accumulated gases or direct them to a suitable gas collection device. The ion exchange solution is conducted similarly through the remaining hollow tubes. A conduit 34, connected to the conduit 19, leads to a safety relief valve, 36, 38, 40.

Once the ion exchange is completed (i.e., once the ion exchange reaches the desired level), the flow of the ion exchange liquid is terminated. Then, the samples are dried with a suitable gas or gases, i.e., an inert gas (such as nitrogen or helium), air, oxygen or a mixture thereof at a desired temperature. The samples can be dried while they are in the tube furnace, by conducting the gas or gases sequentially through the four hollow tubes, as discussed above. Alternatively, the samples can be first washed with water or any other suitable solvent (such as alcohol) by replacing the ion exchange solution with water or any other suitable solvent. A suitable solvent is preferably the same liquid which is used as a solvent in ion exchange (except it has no ions). Thus, if for example, the ion exchange solution uses a lower alcohol (e.g., methanol or ethanol) as a solvent, a suitable solvent for the washing step is such lower alcohol. After this wash, the samples can be dried in suitable gas or gases as discussed herein. If desired, the samples can be calcined again after the drying step and a second ion exchange treatment and wash treatment can be conducted. This cycle can be repeated as often as necessary.

Metal loading can be conducted with a suitable metal solution using the same procedure as ion exchange. The apparatus of FIG. 1 may also be used only for ion exchange or metal loading, without the initial calcination step.

### EXAMPLE 2

FIGS. 2, 2A and 2B are a schematic representation of the embodiment utilizing the modified Soxhlet extractors. The ion exchange apparatus 100 includes three modified Soxhlet extractors 101. A different number of the modified Soxhlet extractors could be used, as indicated in FIG. 2. Each modified Soxhlet extractor comprises a cylindrical vessel 103 (also referred to herein as an “enclosure”) which contains a thimble 105 or a dialysis membrane tube or its portion (as discussed above). While this exemplary embodiment will be described with a thimble, a dialysis membrane tube or its portion can also be used instead. The thimble 105 has a capacity to hold about 50 grams of a molecular sieve. The dialysis membrane tube or its portion may have similar capacity. The thimble is constructed from a cellulose or borosilicate glass or glass or metal mesh material. An inlet conduit 107 with a valve 109 connects each modified Soxhlet extractor to a transfer conduit 111, connected to a pump 113. An intake pipe 112 connects the pump with a vessel 115. An outlet conduit 117 removes the ion exchange solution from the modified Soxhlet extractor, as described below. The conduits 111, 107 and 117 may be heat traced. Temperature in the vessel 115, which contains the ion exchange solution, is controlled by conventional means, such as a thermostat and a heater. In operation, the ion exchange stock solution is drawn from the vessel 115 by a pump 113 through the intake pipe 112. The ion exchange solution is directed by the pump 113 through an intake pipe 112, transfer conduit 111 and inlet conduit 107 into each modified Soxhlet extractor. Valves 109 control access to and rate of flow of the ion exchange solution into each enclosure 103. Alternatively the ion exchange solution can be directed to the modified Soxhlet extractor using a multi-channel peristaltic pump (as shown in FIG. 2B). When the liquid level in the enclosure 103 reaches the height of the syphon, the liquid is drained into the vessel 115 through the outlet conduit 117. The mechanism for draining the liquid into the vessel 115 is syphon action. The process can be continued until the desired level of ion exchange has been achieved.

The same apparatus can be used for metal loading of molecular sieves contained in the thimble by using a suitable metal solution in the vessel 115.

### EXAMPLE 3

FIG. 3 schematically illustrates the embodiment utilizing a plurality of dialysis membrane tubes (or portions of dialysis membrane tubes) or dialysis membrane portions. An apparatus 201 includes a vessel 203 which contains an ion exchange solution 205. The vessel also includes a stirrer 207. Several portions of dialysis membranes 209 (such as any of suitable polyvinylidene difluoride (PVDF) dialysis membranes from Spectra/Por Biotech), each including molecular sieves samples 211, are immersed in the vessel. The molecular sieves samples weigh about 0.5 to 5 grams. The dialysis membrane portions have the dimensions of 2 to 10 cm in length. The dialysis membrane portions are allowed to float freely in the ion exchange solution or can be secured in vessel 203 by any conventional means. The dialysis membrane portions are maintained in the vessel 203 for sufficient time to effect a desired level of ion exchange. Suitable dialysis membrane tubes or portions thereof may be substituted for the dialysis membrane portions. The same apparatus may be used for metal loading of molecular sieves samples.

What is claimed is:

1. An apparatus for treatment of a plurality of molecular sieves samples, comprising:
(a) a plurality of sample holders;
(b) at least one support means, including attached thereto a plurality of elongated, substantially vertically extending hollow tubes, with each hollow tube having attached thereto a plurality of sample holders, each of said hollow tubes being in fluid communication with the sample holders of each respective hollow tube;
(c) a tube furnace for receiving said at least one support means;
(d) a means for supplying an inert gas, air, oxygen or a mixture thereof to each sample holder for a selected time period;
(e) a programmable device for sequentially directing the flow of inert gas, air, oxygen or a mixture thereof to each of said support means and each said sample holder;
(f) a means for varying temperature of the tube furnace; and
(g) a means for supplying an ion exchange liquid or a source of a metal to each said support means and each said sample holder.

2. The apparatus of claim 1, wherein said sample holders are arranged along the length of the hollow tubes, and said sample holders are separated by a distance between consecutive sample holders, each of the hollow tubes being in fluid communication with each sample holder attached to the respective hollow tube.

3. The apparatus of claim 1, wherein said programmable device directs the flow of inert gas, air, oxygen or a mixture thereof to one of the hollow tubes and sample holders attached thereto, while substantially simultaneously maintaining a plurality of other hollow tubes and sample holders attached thereto under a static gas atmosphere.

4. The apparatus of claim 1, wherein each hollow tube includes four to twelve sample holders.

5. The apparatus of claim 1, wherein each sample holder comprises an 8VCR coupling which includes a first filter at an entrance of the coupling and a second filter at the exit of the coupling.

6. The apparatus of claim 1, wherein each said hollow tube includes four sample holders.

7. The apparatus of claim 1, wherein said support means includes four to twelve hollow tubes.

8. The apparatus of claim 1, wherein each sample holder is closed to the outside environment, other than being in fluid communication with said hollow tubes.

9. A process for the treatment of a plurality of molecular sieves samples, comprising:
(a) providing a support means which includes a plurality of elongated, substantially vertically extending hollow tubes, each hollow tube having a plurality of sample holders attached thereto, the hollow tubes being in fluid communication with the sample holders of each respective hollow tube;
(b) placing said molecular sieves samples into said sample holders;
(c) placing said support means in a tube furnace;
(d) heating the molecular sieves samples in the tube furnace;
(e) supplying a flow of an inert gas, air, oxygen or a mixture thereof into one of the hollow tubes, while substantially simultaneously maintaining a plurality of other hollow tubes under static gas atmosphere;
(f) cooling the molecular sieves samples to a temperature suitable for ion exchange of the molecular sieves samples;
(g) supplying an ion exchange liquid into one of the hollow tubes, while substantially simultaneously maintaining a plurality of other hollow tubes under static ion exchange liquid conditions, for a time necessary to effect a desired level of ion exchange in the molecular sieves samples; and
(h) drying the molecular sieves samples.

10. The process of claim 9, which further includes after (g) and before (h), washing the molecular sieves samples.

11. The process of claim 9, wherein the inert gas, air, oxygen or a mixture thereof is supplied to the hollow tube for about 0.5 to about 10 minutes.

12. The process of claim 9, wherein the inert gas, air, oxygen or a mixture thereof is supplied to the hollow tube for a time sufficient to substantially remove an organic directing agent from the molecular sieves samples.

13. The process of claim 9, wherein between 3 and 10 hollow tubes are maintained under a static gas atmosphere.

14. The process of claim 9, wherein the supply of flow of inert gas, air, oxygen or a mixture thereof is effected via a computer controlled system.

15. The process of claim 14, wherein the computer controlled system maintains under static gas atmosphere three hollow tubes.

16. The process of claim 14, wherein said computer controlled system supplies the inert gas, air, oxygen or a mixture thereof to the hollow tube for about 1 to about 10 minutes and maintains under static gas atmosphere the three hollow tubes for about 1 to about 10 minutes.

17. The process of claim 16, wherein said computer controlled system sequentially rotates the three hollow tubes which are maintained under static gas atmosphere and the one hollow tube to which the flow of the inert gas, air, oxygen or a mixture thereof is supplied.

18. An apparatus for the treatment of a plurality of molecular sieves samples, comprising:
(a) a plurality of modified Soxhlet extractors, each modified Soxhlet extractor comprising an enclosure including a container for a molecular sieve sample, an inlet conduit connected to an inlet of the enclosure and an outlet conduit connected to an exit of the enclosure;
(b) a vessel for a treatment solution connected via an intake conduit to a pump;
(c) the pump having connected to its outlet a transfer conduit which is connected to the inlet conduit; and
(d) a means to regulate temperature of the treatment solution in the vessel.

19. The apparatus of claim 18, wherein the container is a thimble container or a dialysis membrane tube.

20. The apparatus of claim 19, wherein the modified Soxhlet reactors are operationally arranged parallel to each other.

21. The apparatus of claim 20, wherein each modified Soxhlet extractor comprises a means for directing the treatment solution from the enclosure to the vessel when a predetermined level of the treatment solution is reached in the enclosure.

22. The apparatus of claim 18, wherein the means to regulate temperature of the treatment solution comprises a thermostatic water or oil bath.

23. The apparatus of claim 18, wherein at least one of the inlet conduit, the outlet conduit or the transfer conduit includes a temperature control means for regulating temperature thereof.

24. The apparatus of claim 23, wherein the temperature control means comprises heat tracing.

25. A process for the treatment of a plurality of molecular sieves samples in the apparatus of claim 18, comprising
(a) placing the samples into the containers;
(b) directing the treatment solution to each container in the respective enclosures through the inlet conduits;
(c) allowing the treatment solution to reach a pre-determined level in the enclosures;
(d) causing the treatment solution to exit the enclosures through the outlet conduits into the vessel.

26. The process of claim 25, wherein the container is a thimble container or a dialysis membrane tube.

27. The process of claim 25, wherein the treatment solution is an ion exchange solution.

28. The process of claim 27, wherein the ion exchange solution is at an elevated temperature.

29. The process of claim 27, wherein the ion exchange solution is circulated to each enclosure until a desired level of ion exchange in each sample is obtained.

30. The process of claim 29, wherein, after the desired level of ion exchange in each sample is obtained, each sample is washed and dried.

31. An apparatus for the treatment of a plurality of molecular sieves samples, comprising:
(a) a vessel including an ion exchange solution, the vessel including a means to circulate the solution;
(b) the vessel further including a means to adjust temperature of the solution; and
(c) a means to maintain a plurality of dialysis membrane tubes, portions of dialysis membrane tubes and/or a plurality of dialysis membrane portions in the vessel.

32. The apparatus of claim 31, wherein each of the dialysis membrane tubes, portions of dialysis membrane tubes and/or dialysis membrane portions includes at least one molecular sieve sample.

33. A process for the treatment of a plurality of molecular sieves samples, comprising:
(a) incorporating at least one molecular sieve sample into a dialysis membrane tube, a portion of dialysis membrane tube and/or a dialysis membrane portion;
(b) placing a plurality of dialysis membrane tubes, portions of dialysis membrane tubes and/or a plurality of dialysis membrane portions, each including at least one molecular sieve sample, into a vessel comprising an ion exchange solution and a means to circulate the solution;
(c) maintaining the vessel at a temperature needed to effect ion exchange of the molecular sieves samples;
(d) stirring the ion exchange solution; and
(e) maintaining the dialysis membrane tubes, portions of dialysis membrane tubes and/or the dialysis membrane portions in the vessel for a sufficient time to effect a desired degree of ion exchange.

34. A process for the treatment of a plurality of molecular sieves samples, comprising:
(a) providing a support means which includes a plurality of elongated, substantially vertically extending hollow tubes, each hollow tube having a plurality of sample holders attached thereto, the hollow tubes being in fluid communication with the sample holders;
(b) placing said molecular sieves samples into said sample holders;
(c) placing said support means in a tube furnace;
(d) heating the molecular sieves samples in the tube furnace to a temperature suitable for ion exchange;
(e) supplying an ion exchange liquid into one of the hollow tubes, while substantially simultaneously maintaining a plurality of other hollow tubes under static ion exchange liquid conditions for a time necessary to effect a desired level of ion exchange; and
(f) drying the molecular sieves samples.

35. The process of claim 34, which after (e) and before (f) further includes washing the molecular sieves samples.

36. The process of claim 34, wherein the ion exchange liquid is supplied to the hollow tube for about 0.5 to about 10 minutes.

37. The process of claim 34, wherein the ion exchange liquid is supplied to the hollow tube for a time sufficient to complete a desired level of ion exchange.

38. The process of claim 34 wherein between 3 and 10 hollow tubes are maintained under the static ion exchange liquid conditions.

39. The process of claim 34, wherein the supply of the ion exchange liquid is effected via a computer controlled system.

40. The process of claim 39, wherein the computer controlled system maintains under static ion exchange liquid conditions three hollow tubes.

41. The process of claim 40, wherein said computer controlled system supplies the ion exchange liquid to the hollow tube for about 1 to about 10 minutes and maintains under static ion exchange liquid conditions the three hollow tubes for about 1 to about 10 minutes.

42. The process of claim 41, wherein said computer controlled system sequentially rotates the three hollow tubes which are maintained under static ion exchange liquid conditions and the one hollow tube to which the ion exchange liquid is supplied.
